(19) United States
(12) Patent Application Publication
(10) Pub. No.: US 2007/0275146 A1
(43) Pub. Date: Nov. 29, 2007

(54) METHOD OF AND DEVICE FOR DELIVERING AN ACTIVE COMPONENT TO A LIQUID FOODSTUFF

(76) Inventors: Steven J. Catani, Athens, GA (US); Ian R. Miller, Chicago, IL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/420,573

(22) Filed: May 26, 2006

(51) Int. Cl. A23L 1/236

(52) U.S. Cl. 426/548

(57) ABSTRACT

Methods and devices for delivering an active component to a liquid foodstuff, for example, a beverage, are provided. More particularly, a method is provided for delivering an active component to a liquid foodstuff wherein a solution that includes the active component is coated on the interior cavity of a container for holding the liquid foodstuff. Also provided are devices for delivering an active component to a liquid foodstuff and methods of making such devices.

### FIELD OF THE INVENTION

The present invention relates to methods to deliver an active component to a liquid foodstuff, for example, a beverage. More particularly, the present invention relates to a method for delivering an active component to a liquid foodstuff including the steps of a) coating at least a portion of an inner surface of a container for a liquid foodstuff, wherein the inner surface has a sidewall and bottom defining a cavity for containing the liquid foodstuff, with a solution of an active component in a solvent and b) introducing the liquid foodstuff into the cavity thereby dispersing the active component throughout the liquid foodstuff without additional mixing. The present invention also relates to devices for sweetening liquid foodstuffs and methods of making such devices.

### BACKGROUND OF THE INVENTION

People often add sweeteners to their foods and beverages. For example, sweeteners are added to beverages, such as, coffee and tea. Sweetening a food or beverage alters its flavor and usually increases its appeal. This behavior is found in all cultures, but is especially prevalent in western cultures.

Personal taste creates considerable variability in the amount of sweetness that one person prefers in a given food or beverage versus another person. For example, the amount of sweetness incorporated into a foodstuff during commercial production may not be adequate to satisfy some consumers while other consumers may find that the same amount of sweetness to be excessive. Moreover, consumers often desire to reduce their caloric intake for health or lifestyle reasons. Therefore, there exists a long-felt need for mechanisms that consumers may use to increase the sweetness of a product at the time of consumption that are consistent with their personal preferences and that produce minimal additional caloric burden.

The availability of high intensity sweeteners provides the ability to minimize the caloric burden involved with adding additional sweetness to a foodstuff, e.g., individual servings of beverages. For example, sucralose is about 500 to about 600 times as sweet as sucrose (a.k.a. table sugar and cane sugar). One teaspoon of sucrose (about 4-5 grams) may be replaced by about 6.7 to 10 milligrams of sucralose. The minute quantities of high intensity sweeteners needed to achieve preferred sweetening of individual servings offer the opportunity to provide new technologies to deliver sweetness to foodstuffs, including individual servings.

Methods for sweetening a liquid foodstuff are known. For example, adding sweetener to an unsweetened iced tea beverage will typically involve several steps—adding the sweetener to the unsweetened iced tea beverage followed by stirring to disperse and dissolve the sweetener to create a sweetened iced tea beverage. Such methods use a sweetener that is typically in a cube, tablet, granular, powdered, or liquid form.

Sweetening individual servings of, for example, a beverage presents a challenge in many food service situations. Frequently, at least one individual packet of a sweetener is provided along with a serving of a beverage. The packet may contain sucrose, or alternatively may contain a high intensity sweetener, such as, sucralose, aspartame, or saccharin.

However, sweetening a beverage using sweetener packets presents a number of disadvantages. For example, once opened, the entire packet and its contents must be disposed of, whether used as sweeter or discarded as waste, since there is no simple way of storing an opened packet without spillage. The consumer opens the packet, empties the contents into the beverage, and then stirs the beverage to obtain dissolve the sweetener into the liquid foodstuff. The residual packaging of the packet, unused sweetener, and the device used to stir the beverage, e.g., straw or stick, create waste. Furthermore, the transportability of individual sweetener packets may be considered by some to be inconvenient due to their size and weight.

Liquid sweetener products have also been developed. These also suffer disadvantages. These products typically dispense sweeteners in a drop-wise manner and produce localized areas of intense sweetness in the foodstuff to which they are added. Moreover, the non-uniformity of drops delivered from a squeeze-type liquid dispenser results in variability in the amount of sweetness delivered per dose. A liquid sweetener added drop-wise to a liquid foodstuff, e.g., a beverage, such as, coffee or tea, will require additional mixing, e.g., stirring, to disperse the sweetener throughout the liquid foodstuff. Moreover, there is no way to spread a liquid sweetener dropwise evenly over a serving of solid foodstuff, such as, a bowl of fruit or cereal.

In view of the foregoing, it would be advantageous to provide a method of delivering an active component, e.g., a sweetener, to a foodstuff without the need for mixing and related devices for doing the same.

### SUMMARY OF THE INVENTION

One embodiment of the present invention is method for delivering an active component to a liquid foodstuff comprising, consisting of, and/or consisting essentially of coating at least a portion of a cavity defining a volume for holding the liquid foodstuff in a liquid foodstuff container with a solution comprising, consisting of, and/or consisting essentially of an active component and a solvent to form a coated cavity, and introducing the liquid foodstuff onto the coated cavity, thereby dispersing the active component into the liquid foodstuff.

Another embodiment of the present invention is a method for delivering sucralose to a beverage comprising, consisting of, and/or consisting essentially of coating at least a portion of a cavity defining a volume for holding the beverage in a beverage container with a mist of a solution comprising, consisting of, and/or consisting essentially of sucralose and water to form a coated cavity and pouring the beverage onto the coated cavity, wherein the amount of sucralose dissolved in the beverage is sufficient to produce a Sucrose Sweetness Equivalent to from about one to about three teaspoons of sucrose.

A further embodiment of the present invention is a method of making a device for delivering an active component to a liquid foodstuff comprising, consisting of, and/or consisting essentially of coating at least a portion of a cavity defining a volume for holding the liquid foodstuff in a liquid foodstuff container with a solution comprising, consisting of, and/or consisting essentially of an active component and a solvent to form a coated cavity and drying the solution to form a layer of the active component on the coated cavity.

An additional embodiment of the present invention is a method of making a device for delivering sucralose to a beverage comprising, consisting of, and/or consisting essentially of coating at least a portion of a cavity defining a volume of from about 6 ounces to about 10 ounces for holding the beverage in a beverage container with a solution comprising, consisting of, and/or consisting essentially of sucralose and water to form a coated cavity and drying the solution to form a layer of sucralose on the coated cavity, wherein the amount of sucralose on the coated cavity is sufficient to produce a Sucrose Sweetness Equivalent to from about one to about three teaspoons of sucrose.

A further embodiment of the present invention is a device for delivering an active component to a liquid foodstuff comprising, consisting of, and/or consisting essentially of a liquid foodstuff container having a cavity defining a volume for holding the liquid foodstuff and a coating on the cavity, the coating comprising, consisting of, and/or consisting essentially of an active component.

Another embodiment of the present invention is a device for sweetening a beverage comprising, consisting of, and/or consisting essentially of a container having a cavity defining a volume for holding a beverage and a coating on the cavity, the coating comprising, consisting of, and/or consisting essentially of sucralose, wherein the volume is from about 6 ounces to about 8 ounces and the amount of sucralose in the coating is sufficient to produce a Sucrose Sweetness Equivalent of from about one to about three teaspoons of sucrose

### BRIEF DESCRIPTION OF THE DRAWINGS

FIG. 1 shows a cross section of an embodiment of the present invention.

FIG. 2 shows a cross section of an embodiment of the present invention.

FIG. 3 shows a cross section of an embodiment of the present invention.

### DETAILED DESCRIPTION OF THE INVENTION

As used herein, the term “liquid foodstuff” means an ingestible material that is a fluid, e.g., a beverage, such as, water, coffee, or tea, or an ingestible material that has a fluid base and retains fluid-like properties, e.g., a soup or sauce. Liquid foodstuffs useful in the present invention include, e.g., coffee, tea, water, seltzer, milk, juices, liquors, spirits, beer, ales, soups, sauces, gravies, and the like. Preferably, the liquid foodstuff is coffee, tea, or water.

As used herein, the term “container” means any inedible structure useful for holding or containing a liquid. Examples of containers useful in the present invention include cups, mugs, bowls, bottles, jugs, cartons, bags, and the like.

As used herein, the term “active component” means any substance that dissolves or can be suspended in a liquid, which includes water with or without other solutes. Examples of useful active components include high intensity sweeteners, nutritive sweeteners, sugar alcohols, flavors, drug substances, vitamins, minerals, texture enhancers, coloring agents, aromas, preservative/buffer systems, and combinations thereof. A preferred active component according to the present invention is a high intensity sweetener.

As used herein, the term “high intensity sweetener” means a substance that provides a high sweetness per unit mass as compared to sucrose and provides little or no nutritive value. Many high intensity sweeteners are known to those skilled in the art and any can be used in the present invention. Examples of high intensity sweeteners for use in the present invention include aspartame, acesulfame, alitame, brazzein, cyclamic acid, dihydrochalcones, extract of Dioscorophyllum cumminsii, extract of the fruit of Pentadiplandra brazzeana, glycyrrhizin, hernandulcin, monellin, mogroside, neotame, neohesperidin, saccharin, sucralose, sweet glycosides of steviol and iso-steviol, thaumatin, salts, esters, derivatives, and combinations thereof. A preferred sweetener according to the present invention is sucralose.

As used herein, a gram (or other given amount) of “Sucrose Equivalent Sweetness” means the amount of high intensity sweetener needed to be added to an 8 ounce glass of water at room temperature in order to provide the same sweetness as an independent 8 ounce glass of water at the same temperature containing 1 gram (or the other given amount) of sucrose. For example, 1/200 gram of aspartame will equal about 1 gram of Sucrose Equivalent Sweetness because aspartame is about 200 times sweeter than sucrose. Similarly, about 1/500 gram to about 1/600 gram of sucralose will provide one gram of Sucrose Equivalent Sweetness because sucralose is about 500 to about 600 times sweeter than sucrose. Therefore, one teaspoon of sucrose (about 4-5 grams) may be replaced by about 6.7 to 10 milligrams of sucralose.

Preferably, the high intensity sweetener is present on the inner surface of the container in an amount sufficient to produce a sweetness equivalent about one-half teaspoon to about 3 teaspoons of sucrose. More preferably, the high intensity sweetener is present on the inner surface of the container in an amount sufficient to produce a sweetness equivalent about one teaspoon of sucrose.

As used herein, all numerical ranges provided are intended to expressly include at least all numbers that fall between the endpoints of ranges.

As used herein, the term “nutritive sweetener” means a substance that provides sweetness and is also absorbable into the bloodstream and may be metabolized to provide energy for immediate use or for storage as fat. Nutritive sweeteners are typically extracted from plants that produce them in various quantities and for various purposes. For example, sucrose, a nutritive sweetener in widespread use, is produced from, e.g. sugar cane and sugar beet roots. Examples of nutritive sweeteners include, e.g., corn syrup, glucose, fructose, tagatose, high fructose corn syrup, lactose, sucrose, trehalose, lactose, arabinose, maltodextrin, soluble starch, inulin, and the like, alone or in combination.

As used herein, “sugar alcohol,” means a food-grade alcohol derived from a sugar molecule. Sugar alcohols useful in the present invention include, for example, isomalt, erythritol, hydrogenated isomaltulose, hydrogenated starch hydrolyzates, lactitol, maltitol, mannitol, sorbitol, xylitol, and combinations thereof.

As used herein, “drug substance” means materials with pharmacological or nutritional benefits. Drug substances useful in the present invention include, for example, acetaminophen, ibuprofen, famotidine, chlorpheniramine, phenylephrine, pseudoephedrine, dextromethorphan, diphenhydramine, brompheniramine, clemastine, phenylpropanolamine, terfenadine, astemizole, loratadine, loperamide, loperamide-N-oxide, ranitidine, cimetidine, tramadol, cisapride, acetylsalicylic acid, doxylamine succinate, pharmaceutically acceptable salts thereof and combinations thereof.

As used herein, “flavor” means any substance that may be employed to produce a desired flavor. Any flavor known to those skilled in the art may used in the present invention. The flavor used may be selected based on the type of foodstuff that will be contacted with the device for delivering an active component. Flavors useful for flavoring coffee include, for example, cream, hazelnut, vanilla, chocolate, cinnamon, and pecan. In contrast, flavors useful for flavoring tea include, for example, lemon, lime, raspberry, peach, and mango. Blends of flavors are also suitable for these applications. Useful flavors include, for example, the above-mentioned flavors and vanillin, butter, butterscotch, tea, orange, tangerine, walnut, caramel, strawberry, banana, grape, plum, cherry, blueberry, pineapple, elderberry, watermelon, bubblegum, cantaloupe, guava, kiwi, papaya, coconut, mint, spearmint, green tea, chai, and pomegranate, and combinations thereof.

As used herein, “texture enhancer” means any substance that may be employed to produce a desired texture. Texture enhancers useful in the present invention include, for example, guar gum, alginate and salts thereof, taro gum, gellan gum, xanthium gum, amalose, amalopectin, konjac, and combinations thereof.

As used herein, “coloring agent” means any substance that may be employed to produce a desired color. Coloring agents useful in the present invention include, for example, FD&C Blue No. 1 (Brilliant Blue), FD&C Blue No. 2 (Indigotine), FD&C Green No. 3 (Fast Green), FD&C Red No. 3 (Erythrosine), FD&C Red No. 40 (Allura Red), FD&C Yellow No. 5 (Tartrazine), FD&C Yellow No. 6 (Sunset Yellow), Annatto Extract, Anthocyanis, Aronia/Redfruit, Beet Juice & Powder, Beta-Carotene, Beta-APO-8-Carotenal, Black Currant, Burnt Sugar, Canthaxanthin, Caramel, Carbo Medicinalis, Carmine, Carmine/Beta-Carotene, Carmine Blue, Carminic Acid, Carrot & Carrot Oils, Chlorophyll, Chlorophyllin, Cochineal Extract, Copper-Chlorophyll, Copper-Chlorophyllin, Curcumin, Curcumin/CU-Chlorophyllin, Elderberry, Grape & Grape Skin Extracts, Hibiscus, Lutein, Mixed Carotenoids, Paprika, Paprika Extract, Paprika Oleoresin, Riboflavin, Saffron, Spinach, Stinging Nettle, Titanium Dioxide, Turmeric, and combinations thereof.

As used herein, “aroma” means any volatile substance that may be employed to produce a desired scent. Aroma components useful in the present invention include, for example, essential oils (citrus oil), expressed oils (orange oil), distilled oils (rose oil), extracts (fruits), anethole (liquorice, anise seed, ouzo, fennel), anisole (anise seed), benzaldehyde (marzipan, almond), benzyl alcohol (marzipan, almond), camphor (cinnamomum camphora), cinnamaldehyde (cinnamon), citral (citronella oil, lemon oil), d-limonene (orange) ethyl butanoate (pineapple), eugenol (clove oil), furaneol (strawberry), furfural (caramel), linalool (coriander, rose wood), menthol (peppermint), methyl butanoate (apple, pineapple), methyl salicylate (oil of wintergreen), neral (orange flowers), nerolin (orange flowers), pentyl butanoate (pear, apricot), pentyl pentanoate (apple, pineapple), sotolon (maple syrup, curry, fennugreek), strawberry ketone (strawberry), substituted pyrazines, e.g., 2-ethoxy-3-isopropylpyrazine; 2-methoxy-3-sec-butylpyrazine; and 2-methoxy-3-methylpyrazine (toasted seeds of fenugreek, cumin, and coriander), thujone juniper, common sage, Nootka cypress, and wormwood), thymol (camphor-like), trimethylamine (fish), vanillin (vanilla), salts, derivatives, and combinations thereof. Preferred aromas according to the present invention are essential oils (citrus oil), expressed oils (orange oil), distilled oils (rose oil), extracts (fruits), benzaldehyde, d-limonene, furfural, menthol, methyl butanoate, pentyl butanoate, and combinations thereof.

As used herein, “preservative/buffer system” means any food grade substance that may be employed to extend the shelf life of another active component. Preservative/buffer systems useful in the present invention include, for example, a preservative system selected from the group consisting of potassium sorbate, sodium benzoate, potassium benzoate, methyl gallate, propyl gallate, ethylenediaminetetraacetate, methyl paraben, propyl paraben and mixtures thereof, a buffering system selected from the group consisting of citric acid and sodium citrate, citric acid and potassium citrate, phosphoric acid and sodium phosphate, phosphoric acid and potassium phosphate, arginine and arginine HCl, lysine and lysine HCl, tartaric acid and sodium tartrate, tartaric acid and potassium tartrate, adipic acid and sodium adipate, adipic acid and potassium adipate, malic acid and sodium malate, malic acid and potassium malate, and sodium phosphate monobasic and sodium phosphate dibasic and a liquid, wherein the pH of the composition is from about pH 4.0 to about pH 5.5, and combinations thereof. Preferred preservative/buffer systems according to the present invention are a preservative system consisting of potassium sorbate and sodium benzoate, a buffering system consisting of citric acid and sodium citrate, and combinations thereof.

As used herein, the term “solution” means a composition containing an active component dissolved or suspended in a solvent. Preferably, the solution contains sucralose dissolved in water. In an embodiment of the invention the solution contains sucralose and a lemon flavor dissolved in water.

As used herein, the term “solvent” means any food-grade liquid useful to dissolve or suspend one or more active components. Examples of solvents useful in the present invention include water, ethanol, milk, ethyl acetate, propylene glycol, and combinations thereof. Preferably, the solvent is water.

As used herein, a “food-grade” material is one that conforms to the standards for foods deemed safe for human consumption set forth in the Codex Alimentarius produced by the World Health Organization (1999).

The solution may be coated on the inner surface of the container in any manner. For example, the solution may be sprayed, brushed, or printed onto the inner surface of the container. A volume of the solution may also be poured into the cavity, the container manipulated, e.g., swirled, turned, or rocked back and forth, to spread the solution over at least a portion of the inner surface of the container, and the excess solution, if any, poured out of the cavity. Preferably, a uniform mist of the solution is sprayed on at least a portion of the inner surface of the container to coat it.

As used herein, the term “uniform mist” means an aerated form of the solution made up of substantially evenly distributed, fine droplets. Such mist results in a substantially even distribution of the active component on the inner surface of the container, i.e., about the same mass of active component/unit surface area is delivered to all areas of the coated portion of the inner surface of the container.

The uniform mist may be produced by any known spraying method or device. Examples of spraying methods and devices useful in the present invention include any device with a nozzle and a means to provide a pressurized fluid to said nozzle. These may include, for example, motor driven centrifugal or positive displacement pumps, finger driven positive displacement pumps, finger driven squeeze pumps, aerosol pressurization, and other methods and devices known to those skilled in the art. Preferably, the spraying device is a finger driven squeeze pump.

The coating may be applied to a finished container having a cavity or to the container during manufacturing, e.g., before a cavity is formed by sidewall and bottom. The container may be opaque or transparent. If the container is transparent, a coating having an active component may be applied as an indicia that has the correct orientation when viewed from the outside of the container. For example, a logo may appear backwards when the cavity is viewed from above, but appears as the correct orientation when the sidewall or bottom is viewed from the outside looking in.

The coating may be applied as a discrete pattern and/or multiple layers. Where multiple layers are desired, it is useful to apply a first layer, dry the first layer, apply the second layer in any desired pattern or indicia and dry the second layer. This process may be repeated.

As used herein, the term “discrete” means a distinct, unconnected, discontinuous element or entity. For example, a logo made from two colors may be considered a discrete element. The phrase “discrete pattern” therefore, shall mean a pattern of discrete entities. A series of butterflies spaced apart shall be considered a discrete pattern and may make up the indicia.

As used herein, the term “indicia” refers to an image or a design. The image or design may be a symbol, figure, line, character or similar color-containing graphic that depicts a color difference from the substrate that the indicia is printed on. The indicia may include multiple colors (e.g., at least two colors, black and white, or grayscale) and may include flowers, swirls, dots, stars, stripes, lines, squares, suns, zig-zags, animals, public figures, logos, cartoon characters, seasonal icons, holiday icons, and other popular symbols.

One method of coating a container involves a consumer self-coat in a container with a solution containing an active component. A container may be at a location where the foodstuff is to be introduced into the cavity, e.g., a coffee shop. In addition, at least one spraying device containing the active component may be provided at a location where the foodstuff is to be introduced into the cavity. Alternatively, the consumer may carry a spraying device containing the active component(s) selected by them to the location of the cups.

Just prior the introduction the liquid foodstuff into the cavity, at least a portion of the inner surface of the container is coated with a mist of active component-containing solution from the spraying device. This allows customization of the amount of active component, e.g., sweetness, by the user, while maintaining rapid and even dispersement without stirring.

Alternatively, at least a portion of the inner surface of numerous containers may be coated at the location where the foodstuff is to be introduced into the cavity. Containers may be coated with different forms or concentrations of the active component. In this manner, the containers may be prepared in anticipation of the consumers' desires. For example, containers coated with different sweetness levels (e.g. 1-3 teaspoons of SES) or having different flavors, aromas, or both may be produced. A consumer orders a liquid foodstuff, e.g. coffee, and requests a desired sweetness and/or flavor. The appropriate pre-coated container may then be selected to quickly produce the liquid foodstuff with the active component and concentration ordered.

The solution may be dried after being coated on the inner surface of the container to form a dried layer of the active component. Drying may be accomplished in any convenient manner. For example, the coated container may simply be exposed to the environment for a sufficient time to dry the solution or the coated container may be dried under increased temperature and/or decreased humidity in, e.g. an oven.

When the liquid foodstuff is introduced into the cavity of the coated container, e.g., by pouring, the coating is dissolved (if dried) and dispersed throughout the liquid foodstuff without the need for additional mixing, e.g., stirring.

Sucralose can be delivered to a beverage by a) coating at least a portion of an inner surface of a container, wherein the inner surface has a sidewall and bottom defining a cavity for containing the beverage, with a mist of a solution of sucralose in water and b) pouring the beverage into the container thereby dispersing the sucralose throughout the beverage without additional mixing, wherein the amount of sucralose dispersed in the beverage is sufficient to produce a sweetness equivalent to from about one to about three teaspoons of sucrose.

The amount of liquid foodstuff, e.g., beverage, added to the container can be any amount selected by the consumer. It may be from about 1 to about 32 ounces, about 4 to about 10 ounces, about 6 to about 8 ounces, and the like. Depending on the size of container used and the amount of solution coated thereon, the amount of active component can vary. For example, where a sweetener is the active component, a sucrose sweetness equivalent of from about 1 to about 3 teaspoons of sucrose is produced.

A method of making a device for delivering an active component to a liquid foodstuff includes the steps of a) coating at least a portion of an inner surface of a container for a liquid foodstuff, wherein the inner surface has a sidewall and bottom defining a cavity for containing the liquid foodstuff, with a solution of an active component in a solvent and b) drying the solution to form a layer of the active component on the inner surface of the container.

In addition, a plurality of containers can be coated and dried for later use. For example, large quantities of the devices of the present invention may be produced by hand or by automated methods by providing a solution containing a least one active component, coating a plurality of containers (e.g., about 50 to 5,000) with at least one layer of solution, and drying the plurality of the containers. In this method, the container, composition of the solution, quantity and composition of the active component, coating, spraying, and drying are as described above.

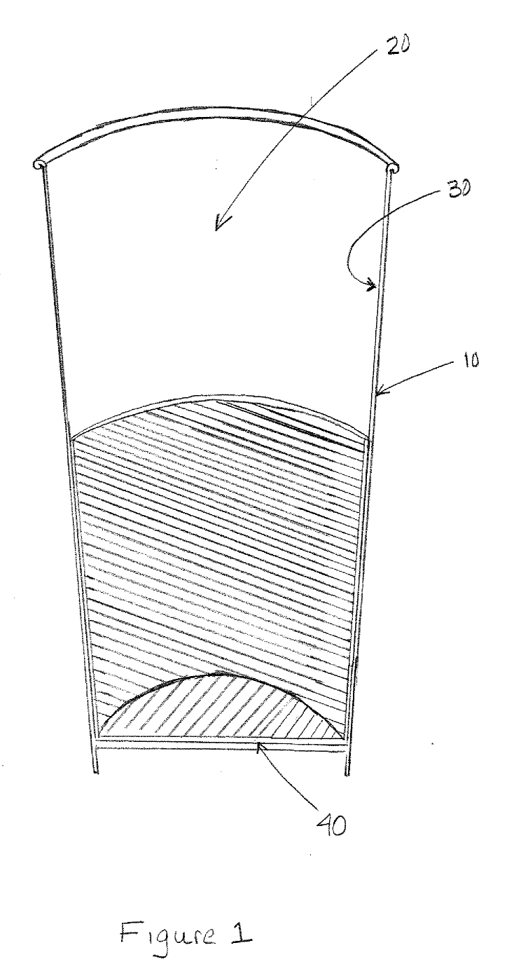

Turning now to FIG. 1, a cross-section of a disposable cup is depicted. The disposable cup has an outer surface (10) and an inner surface (20) with a sidewall (30) and a bottom (40). The bottom and a portion of the sidewall are coated with an active component (shaded area—thickness not to scale).

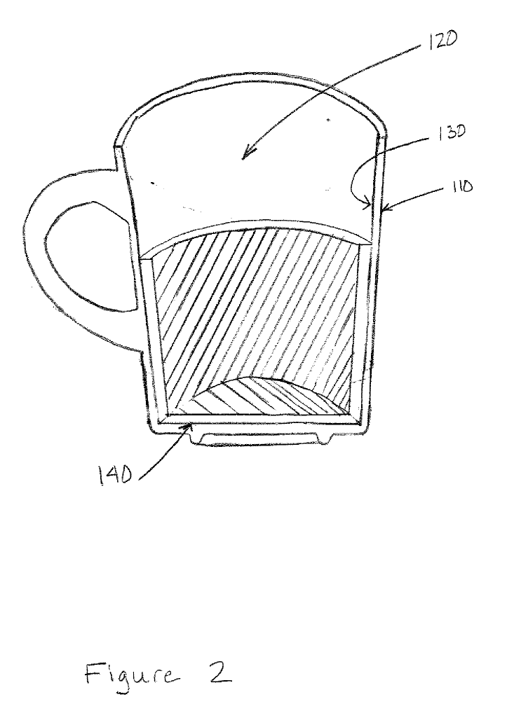

FIG. 2 depicts a mug or cup as a container. The mug or cup has an outer surface (110) and an inner surface (120) with a sidewall (130) and a bottom (140). The bottom and a portion of the sidewall are coated with an active component (shaded area—thickness not to scale).

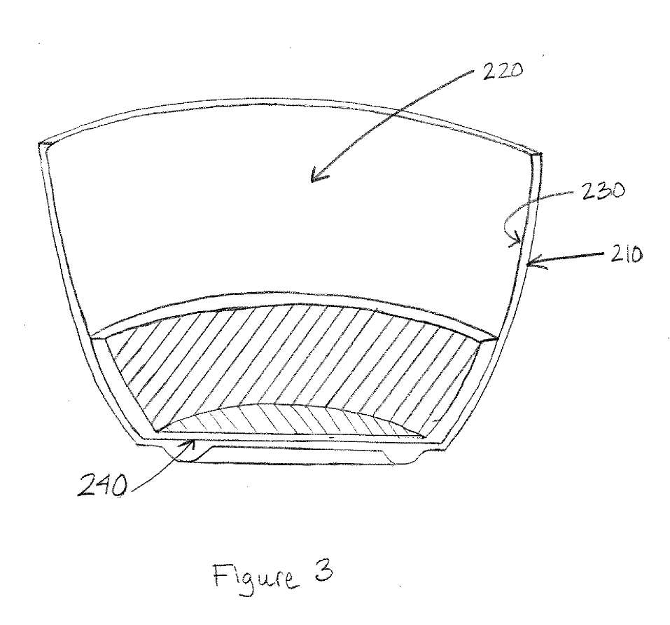

FIG. 3 shows a bowl as a container. The bowl has an outer surface (210) and an inner surface (220) with a sidewall (230) and a bottom (240). The bottom and a portion of the sidewall are coated with an active component (shaded area—thickness not to scale).

The following examples are provided to further illustrate the compositions and methods of the present invention. These examples are illustrative only and are not intended to limit the scope of the invention in any way.

### EXAMPLES

### Example 1

A device for sweetening a liquid foodstuff of the present invention is made with a bowl as the container. The solution is made by combining 25.31 grams of sucralose with 183.11 milliliters of tap water. The solution is then heated to about 130° C. and mixed until clear. The solution is allowed to cool to room temperature.

The bottom and a portion of the sidewall of the bowl are sprayed with 0.1 milliliters of the solution. The bowl is dried in an oven at about 110° C. overnight to dry the coating.

Dry cereal is placed in the bowl. About 8 ounces of milk are then poured over the cereal. The agitation of the poured milk dissolves and disperses the sucralose throughout the milk. A tester reports that, without stirring, the device produces a sweetness in the milk equivalent to about two teaspoons of sucrose.

### Example 2

A device for sweetening a liquid foodstuff of the present invention is made with a disposable cup as the container. A solution is made by combining 2 grams of sucralose with 50 milliliters of tap water. The solution is then heated to about 130° C. and mixed until clear. The solution is allowed to cool to room temperature.

The bottom and a portion of the sidewall of the cup are sprayed with 0.25 milliliters of the solution. The cup is dried in an oven at about 110° C. overnight to dry the coating.

About 8 ounces of hot coffee are poured into the disposable cup. The agitation of the coffee dissolves and disperses the sucralose throughout the coffee. A tester reports that, without stirring, the device produces a sweetness in the coffee equivalent to about one teaspoon of sucrose.

### Example 3

A device for sweetening a liquid foodstuff of the present invention is made with a mug as the container. A solution is made by combining 2 grams of sucralose and 100 milligrams of lemon flavor with 50 milliliters of tap water. The solution is then heated to about 130° C. and mixed until clear. The solution is allowed to cool to room temperature.

The bottom and a portion of the sidewall of the mug are sprayed with 0.25 milliliters of the solution. The mug is dried in an oven at about 110° C. overnight to dry the coating.

About 8 ounces of hot herbal tea are poured into the mug. The agitation of the herbal tea dissolves and disperses the sucralose and lemon flavor throughout the herbal tea. A tester reports that, without stirring, the device produces a sweetness in the herbal tea equivalent to about one teaspoon of sucrose and a pleasing lemon flavor.

### Example 4

A sweetener is delivered to a liquid foodstuff using the method of the present invention. A finger driven squeeze pump delivering 0.1 milliliters of solution per spray is provided as a spraying device.

A solution is made by combining 25.31 grams of sucralose with 183.11 milliliters of tap water. The solution is then heated to about 130° C. and mixed until clear. The solution is then allowed to cool to room temperature. Once cooled a portion of the solution is loaded into a reservoir and the reservoir is attached to the spraying device.

The spraying device is used to deliver two sprays to the inner surface of a coffee cup. Coffee is brewed and 8 ounces are poured into the coffee cup. A tester tastes the coffee and reports that, without stirring, the spray produces a sweetness in the coffee equivalent to about two teaspoons of sucrose.

The scope of the present invention is not limited by the description, examples, and suggested uses herein and modifications can be made without departing from the spirit of the invention. Thus, it is intended that the present invention cover modifications and variations of this invention provided that they come within the scope of the appended claims and their equivalents.

What is claimed is:

1. A method for delivering an active component to a liquid foodstuff comprising:
(a) coating at least a portion of a cavity defining a volume for holding the liquid foodstuff in a liquid foodstuff container with a solution comprising an active component and a solvent to form a coated cavity, and
(b) introducing the liquid foodstuff onto the coated cavity, thereby dispersing the active component into the liquid foodstuff.

2. A method according to claim 1, wherein the active component is selected from the group consisting of high intensity sweeteners, nutritive sweeteners, sugar alcohols, flavors, drug substances, vitamins, minerals, texture enhancers, coloring agents, aromas, preservative/buffer systems, and combinations thereof.

3. A method according to claim 2, wherein the active component is a high intensity sweetener.

4. A method according to claim 3, wherein the high intensity sweetener is selected from the group consisting of aspartame, acesulfame, alitame, brazzein, cyclamic acid, dihydrochalcones, extract of Dioscorophyllum cumminsii, extract of the fruit of Pentadiplandra brazzeana, glycyrrhizin, hernandulcin, monellin, mogroside, neotame, neohesperidin, saccharin, sucralose, sweet glycosides of steviol and iso-steviol, thaumatin, salts, derivatives, and combinations thereof.

5. A method according to claim 4, wherein the high intensity sweetener is present on the inner surface of the container in an amount sufficient to produce a sucrose sweetness equivalent to about one half teaspoon to about three teaspoons of sucrose.

6. A method according to claim 5, wherein the high intensity sweetener is present on the inner surface in an amount sufficient to produce a sweetness equivalent to about one teaspoon of sucrose.

7. A method according to claim 4, wherein the high intensity sweetener is sucralose.

8. A method according to claim 2, wherein the active component is a combination of sucralose and a flavor selected from the group consisting of lemon, raspberry, green tea, chai, pomegranate, and combinations thereof.

9. A method according to claim 1, wherein the solvent is selected from the group consisting of water, ethanol, milk, ethyl acetate, propylene glycol, and combinations thereof.

10. A method according to claim 9, wherein the solvent is water.

11. A method according to claim 1, wherein the coating step comprises spraying a uniform mist of the active component-containing solution onto at least a portion of the inner surface of the container.

12. A method according to claim 1, further comprising drying the active component-containing solution after the coating step.

13. A method according to claim 3, wherein the solution comprises an additional active component.

14. A method according to claim 13, wherein the additional active component is a preservative/buffer system.

15. A method for delivering sucralose to a beverage comprising:
(a) coating at least a portion of a cavity defining a volume for holding the beverage in a beverage container with a mist of a solution comprising sucralose and water to form a coated cavity and
(b) pouring the beverage onto the coated cavity, wherein the amount of sucralose dissolved in the beverage is sufficient to produce a Sucrose Sweetness Equivalent to from about one to about three teaspoons of sucrose.

16. A method of making a device for delivering an active component to a liquid foodstuff comprising:
(a) coating at least a portion of a cavity defining a volume for holding the liquid foodstuff in a liquid foodstuff container with a solution comprising an active component and a solvent to form a coated cavity and
(b) drying the solution to form a layer of the active component on the coated cavity.

17. A method according to claim 16, wherein a plurality of containers is coated and dried.

18. A method according to claim 16, wherein the coating step comprises spraying a uniform mist of the solution onto at least a portion of the inner surface of the container.

19. A method according to claim 16, wherein the active component is sucralose.

20. A method according to claim 19, wherein the sucralose is present on the inner surface in an amount sufficient to produce a sweetness equivalent to from about one half teaspoon to about three teaspoons of sucrose.

21. A method according to claim 20, wherein the sucralose is present on the inner surface in an amount sufficient to produce a sweetness equivalent to about one teaspoon of sucrose.

22. A method according to claim 16, wherein the active component is a combination sucralose and a flavor selected from the group consisting of lemon, raspberry, green tea, chai, and pomegranate, and combinations thereof.

23. A method according to claim 16, wherein the solvent is water.

24. A method according to claim 16, wherein the coating on the cavity comprises indicia.

25. A method of making a device for delivering sucralose to a beverage comprising:
(a) coating at least a portion of a cavity defining a volume of from about 6 ounces to about 10 ounces for holding the beverage in a beverage container with a solution comprising sucralose and water to form a coated cavity and
(b) drying the solution to form a layer of sucralose on the coated cavity, wherein the amount of sucralose on the coated cavity is sufficient to produce a Sucrose Sweetness Equivalent to from about one to about three teaspoons of sucrose.

26. A device for delivering an active component to a liquid foodstuff comprising a) a liquid foodstuff container having a cavity defining a volume for holding the liquid foodstuff and b) a coating on the cavity, the coating comprising an active component.

27. A device according to claim 26, wherein the active component is sucralose.

28. A device according to claim 27, wherein sucralose is present in an amount sufficient to produce a sweetness equivalent to about one half teaspoon to about three teaspoons of sucrose.

29. A device according to claim 28, wherein the sucralose is present to produce a sweetness equivalent to about one teaspoon of sucrose.

30. A device according to claim 26, wherein the active component is a combination sucralose and a flavor selected from the group consisting of lemon, raspberry, green tea, chai, pomegranate, and combinations thereof.

31. A device according to claim 26, wherein the container is selected from the group consisting of cups, mugs, bowls, pitchers, tureens, pots, and pans.

32. A device according to claim 31, wherein the container is cup for a hot beverage.

33. A device according to claim 32, wherein the container is a disposable coffee cup.

34. A device for sweetening a beverage comprising a) a container having a cavity defining a volume for holding a beverage and b) a coating on the cavity, the coating comprising sucralose, wherein the volume is from about 6 ounces to about 8 ounces and the amount of sucralose in the coating is sufficient to produce a Sucrose Sweetness Equivalent of from about one to about three teaspoons of sucrose.
